(19) United States
(12) Patent Application Publication
(10) Pub. No.: US 2018/0212389 A1
(43) Pub. Date: Jul. 26, 2018

(54) ELECTRIC MOTOR BRUSH HOLDER FOR A MOTOR VEHICLE STARTER

(71) Applicant: Valeo Equipements Electriques Moteur, Creteil (FR)

(72) Inventors: Laurent Odin, Isle D'abeau (FR); Alain Bost, Isle D'abeau (FR); Marie-Ange Nalin, Isle D'abeau (FR)

(73) Assignee: Valeo Equipements Electriques Moteur, Creteil (FR)

(21) Appl. No.: 15/745,781

(22) PCT Filed: Jul. 19, 2016
(86) PCT No.: PCT/FR2016/051859

§ 371 Date: Jan. 18, 2018

(30) Foreign Application Priority Data
Jul. 20, 2015 (FR) 1556822

(51) Int. Cl. H01R 39/38; H01R 39/36; H02K 5/14; H02K 13/10

(52) U.S. Cl. CPC H01R 39/383; H01R 39/36; H02K 13/10; H02K 5/148; H01R 39/385

(57) ABSTRACT

An electric motor brush holder for a motor vehicle starter includes a mounting plate, at least one cage mounted on the mounting plate, where the cage has a housing and at least one opening, at least one brush positioned inside said housing of the cage, and a conductive braid connected to the brush, said conductive braid passing through the opening of the cage, where the conductive braid is supported at least on the portion thereof passing through said opening.

The present invention relates to an improved electric motor brush holder for a motor vehicle starter. The invention finds particularly advantageous, but not exclusive, application with motor vehicle starters, in particular those installed in vehicles equipped with the operation of stopping and automatic restarting the thermal engine (operation known as “stop and start” in English).

In a commonly known way, a brush holder is mounted on the rotor shaft of a starter so as to allow brushes made from electrically conductive material to cooperate with an electric commutator rigidly joined to the rotor shaft. That enables the rotor to be electrically supplied by commutation of the electric current into the conductors of the rotor.

For this purpose, the brush holder includes a mounting plate supporting a set of cages, each serving as housing for a brush. Each brush comprises a face intended to rub against the conducting segments of the commutator connected to the winding of the rotor. Flexible means, such as a spring, exerts pressure on each brush housed in a cage in the direction of the commutator to provide contact between the brush and the commutator segments.

The brushes have alternate polarities. Thus the positive polarity brushes, via their respective braid, are electrically connected to an inter-brush connector with which the supply wire coming from the contactor of the starter is also electrically connected. In addition, the brushes intended for returning the current are electrically connected to the earth of the machine by means of their respective braid.

Loss of pressure of the brushes on the commutator has been observed during the life of the starter, tending to generate electric arcs, which accelerates wear of the brushes. This phenomenon is particularly problematic for starters of the “stop and start” type, which have to endure a very large number of operating cycles (about 250000 cycles).

The invention in particular aims at overcoming this disadvantage effectively by proposing an electric motor brush holder for a motor vehicle starter comprising:
a mounting plate,
at least one cage mounted on said mounting plate, said cage comprising a housing and at least one opening,
at least one brush positioned inside said housing of said cage, and
a conductive braid connected to said brush, said conductive braid passing through said opening of said cage, characterized in that said conductive braid is supported at least on the portion thereof passing through said opening.

The invention thus enables any contact between the brush braids with the edge of the cage to be avoided, which prevents friction between the braid and the cage. Loss of pressure of the brushes on the commutator is therefore prevented.

According to an embodiment, the portion of said conductive braid passing through said opening is positioned remotely from the edges of said opening of said cage.

According to an embodiment, the braid includes a connection part located only inside the brush and an exit part located only outside the brush, the exit part of the braid comprising the portion passing through the opening and in which the exit part, over a portion of its length comprising at least the portion passing through said opening, contains the support means and in which the portion of the braid of the exit part is supported differently than by the connection part in the brush.

According to an embodiment, said conductive braid is supported by means of a sheath.

According to an example of the above embodiment, the sheath comprises a first radial surface relative to the braid and a surface surrounding the braid and a second radial surface relative to the braid, the first

surface being closer to the brush than the second surface, and in which this first radial surface is remote from and opposite the brush or is in contact with the brush.

According to an example of the above embodiment, the sheath extends to the maximum around the portion of the braid leaving the brush. In other words, the portion of the braid in the brush is not surrounded directly or indirectly by the sheath. According to an example of the above embodiment, the braid comprises a connection part located only inside the brush and an exit part located only outside the brush, the exit part of the braid comprising the portion passing through the opening and in which the sheath surrounds only one length of the exit part, including at least the portion passing through the opening.

According to an embodiment, said conductive braid is supported through deformation by compaction.

According to an example of the above embodiment, said braid comprises a compaction section at the portion passing through the opening different from the portion of the braid inside the brush.

According to an example of the above embodiment in combination with or without the example described previously, the braid comprises a connection part located only inside the brush and an exit part located only outside the brush, the exit part of the braid comprising the portion passing through the opening and in which a length of the exit part including at least the portion passing through the opening is deformed by compaction.

According to an embodiment, said conductive braid is supported by a supply of tin solidifying said conductive braid locally.

According to an example of the above embodiment, the braid comprises a connection part located only inside the brush and an exit part located only outside the brush, the exit part of the braid comprising the portion passing through the opening and in which the tin is located only over a length of the exit part including at least the portion passing through the opening.

According to an embodiment, the at least one brush is a negative brush. Such a brush does not need to be insulated from the plate via the sheath, which then provides only a support function at the brush exit.

According to another embodiment, each conductive braid of every brush is supported at least on the portion passing through said opening.

According to an embodiment, said cage is made from metal. That enables the dimensions of the cage to be better controlled.

According to an embodiment, said brush holder comprises at least one spring exerting pressure on the brush in the direction of a commutator.

According to an embodiment, said spring is a coiled spring.

According to an embodiment, the range of pressure exerted by said spring on said brush lies between 20 and 35N, and in particular amounts to 25N.

According to an embodiment, said conductive braid is arranged so as not to generate friction if said brush wears in the direction of a contactor.

The object of the invention is also an electric motor comprising a brush holder as defined previously.

The invention in addition relates to a motor vehicle starter containing an electric motor as defined previously.

The invention will be better understood on reading the description below and on examining the figures which accompany it. These figures are only given on a purely illustrative, but by no means restrictive, basis of the invention.

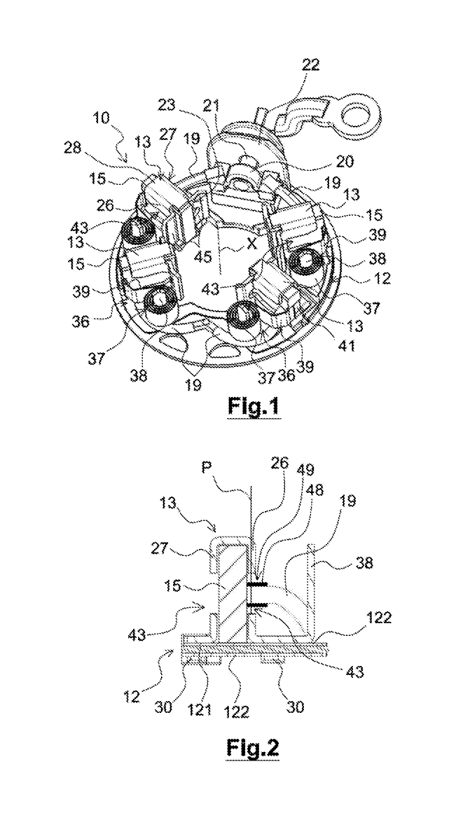

FIG. 1 is a perspective view of a brush holder for an electric motor according to the present invention;

FIG. 2 is a side view of a negative polarity brush provided with a support sheath according to the present invention.

Identical, similar or analogous elements keep the same reference symbol from one figure to the next.

FIG. 1 shows a brush holder 10 according to the invention intended to be used with a motor vehicle starter. This brush holder 10 comprises a mounting plate 12 of substantially annular form on which a set of cages 13 is fixed, each serving as housing for a brush 15. Axis X of mounting plate 12 corresponds to the axis of brush holder 10.

Mounting plate 12 is a cast solid piece comprising a metal panel 121 and moulded layers 122 on both sides of metal panel 121 (see FIG. 2). Layers 122 are made from a plastic material providing good electric insulation.

Mounting plate 12 and cages 13 which it supports are fixed on a cap (not shown) forming a rear bearing for the rotor shaft of the electric machine. In addition, the central part of plate 12 has an opening allowing the passage of an electric machine rotary commutator.

Each brush 15 is mounted so as to slide inside a cage 13 which is open on the side of axis X to allow brushes 15 to make electric contact with segments borne by the commutator.

Brushes 15 have alternate polarities. Thus positive polarity brushes 15, via their respective braid 19, are electrically connected to an inter-brush connector 20 with which the supply wire coming from the contactor of the starter is also electrically connected. In this case, the inter-brush connector 20 is connected to the supply wire via a pin 21 passing through a grommet 22 cooperating with the carcass of the starter to ensure brush holder 10 is properly sealed.

Positive brushes 15 and their corresponding cages 13 are electrically insulated from the negative polarity for good performance of the starter. This insulation is obtained by moulded layers 122.

Flexible braids 19 are advantageously made from copper or copper alloy to facilitate welding. In addition, negative polarity brushes 15 intended for returning the current are electrically connected to the earth of the machine by means of their respective braid 19 welded onto panel 121 of plate 12.

More precisely, each cage 13 has a housing 23 for brush 15 delimited by two side walls 26, 27 facing each other and connected together by a higher joining wall 28. Each cage 13 for example could be obtained by folding a thin steel plate so as to substantially form an omega, the end branches of which are fixed on plate 12 via fixing means 30 shown in FIG. 2. Fixing means 30 can have legs inserted in the corresponding holes of plate 12 and folded towards each other against plate 12. Alternatively, fixing means 30 have rivets.

Making cages 13 from metal enables the dimensions of the cage to be better controlled. Alternatively, cages 13 are produced from a plastic material. In order to increase the rigidity of cages 13, the latter could be provided with wings 45 extending on both sides of the open face located on the side of the commutator.

In addition, a coiled spring 36 associated with each cage 13 radially attracts the corresponding brush 15 towards the contact segments of the commutator. For this purpose, each spring 36 comprises a rolled part 37 formed by a plurality of coils which is mounted around a lug 38, as well as an arm 39 supported against a face of brush 15 opposite the face in contact with the commutator segments. The range of pressure exerted by spring 36 on brush 15 lies between 20 and 35N, and in particular amounts to 25N.

Lug 38 in this case is obtained by folding one of the end branches of cage 13. The side walls 26, 27 each have an opening 43 for the passage of arm 39 of spring 36 and/or braid 19 of the corresponding brush 15. Thus, for the negative brushes, arm 39 and braid 19 pass through same opening 43. For the positive brushes, arm 39 and braid 19 each pass through a different opening 43.

The braid comprises a connection part located only inside the brush and an exit part located only outside the brush. The exit part of braid 19 comprises the portion of the braid passing through opening 43. The exit part, over a portion of its length comprising at least the portion passing through said opening, contains the support means.

In this case the portion of the braid of the exit part is supported differently than by the connection part in the brush.

As shown in FIG. 2, each braid 19 is supported by means of a sheath 48 at least on portion 49 thereof passing through opening 43, i.e. at least on portion 49 of braid 19 intersected by plane P where side wall 26, in which opening 43 is provided, extends. Portion 49 of braid 19 passing through opening 43 via sheath 48 is thus positioned remotely from the edges of opening 43 of cage 13.

Each sheath 48, for example made from a plastic material, is positioned at the exit of brush 15, i.e. at the junction between braid 19 and the face of brush 15 from where braid 19 originates. Sheath 48 or portion 49 of the corresponding braid for example extends from the exit of brush 15 over a length of less than 1 cm, in particular on the negative brushes 15 which do not need to be insulated from plate 12 connected to earth. Sheath 48 of positive brushes 15 in addition could possibly be longer to provide electrical insulation of positive braids 19 from plate 12.

The invention thus enables any contact between braids 19 of positive and negative brushes 15 with the edge of the corresponding cages 13 to be avoided, which prevents friction between braids 19 and cages 13. Loss of pressure of brushes 15 exerted on the commutator by the action of the coiled springs 36 is therefore prevented.

The sheath comprises a first radial surface relative to the braid and a surface surrounding the braid and a second radial surface relative to the braid, the first surface being closer to

the brush than the second surface, and in which this first radial surface is remote from and opposite the brush or is in contact with the brush.

The sheath extends to the maximum around the exit part of the braid leaving the brush. In other words, the connection part of the braid in the brush is not surrounded directly or indirectly by the sheath.

Thus the sheath surrounds only a length of the exit part including at least the portion passing through the opening.

Alternatively, each braid 19 is supported on portion 49 thereof passing through the corresponding opening 43 through deformation by compaction, performed for example by electrolysis.

Said braid can comprise a compaction section at the portion passing through the opening different from the portion of the braid inside the brush.

A length of the exit part including at least the portion passing through the opening is deformed by compaction.

Alternatively, each braid 19 is supported on portion 49 thereof passing through the corresponding opening 43 by a supply of tin solidifying braid 19 locally.

The exit part of the braid comprising the portion passing through the opening and in which the tin is located over only a length of the exit part including at least the portion passing through the opening.

Alternatively, brush holder 10 comprises more than four brushes 15, it being possible for each brush 15 to be associated with another brush 15 positioned on the side opposite plate 12 for example.

Alternatively, the coiled spring 36 is replaced by a helicoid spring.

Brush holder 10 here is an electric motor brush holder for a motor vehicle starter. Alternatively, brush holder 10 could also belong to an alternator or an alternator-starter.

Of course, the above description was only given by way of example and does not restrict the scope of the invention from which there would be no departure if the various elements were replaced by any other equivalents.

1. An electric motor brush holder for a motor vehicle starter comprising:
a mounting plate;
at least one cage mounted on said mounting plate, said at least one cage comprising a housing and at least one opening;
at least one brush positioned inside said housing of said cage; and
a conductive braid connected to said brush, said conductive braid passing through said opening of said cage,
wherein said conductive braid is supported at least on the portion thereof passing through said opening.

2. The brush holder according to claim 1, wherein said portion of said conductive braid passing through said opening is positioned remotely from the edges of said opening of said cage.

3. The brush holder according to claim 1, in which the braid comprises a connection part located only inside the brush and an exit part located only outside the brush, the exit part of the braid comprising the portion passing through the opening and in which the exit part, over a portion of its length comprising at least the portion passing through said opening, contains the support means and in which the portion of the braid of the exit part is supported differently than by the connection part in the brush.

4. The brush holder according to claim 1, wherein said conductive braid is supported by a sheath.

5. The brush holder according to claim 1, wherein said conductive braid is supported through deformation by compaction.

6. The brush holder according to claim 1, wherein said conductive braid is supported by a supply of tin solidifying said conductive braid locally.

7. The brush holder according to claim 1, wherein the at least one brush is a negative brush.

8. The brush holder according to claim 1, wherein said cage is made of metal.

9. The brush holder according to claim 1, further comprising at least one spring exerting pressure on the brush in the direction of a commutator.

10. The brush holder according to claim 9, wherein said spring is a coiled spring.

11. The brush holder according to claim 7, wherein the range of pressure exerted by said spring on said brush lies between 20 and 35N.

12. The brush holder according to claim 1, wherein said conductive braid is arranged so as not to generate friction when said brush wears in the direction of a contactor.

13. An electric motor comprising a brush holder as defined according to claim 1.

14. A motor vehicle starter comprising an electric motor as defined according to claim 13.
